(19) United States
(12) Patent Application Publication
(10) Pub. No.: US 2011/0102671 A1
(43) Pub. Date: May 5, 2011

(54) Picture in Picture Video Display for Low Power Device

(75) Inventor: Richard Tsai, Cupertino, CA (US)

(73) Assignee: APPLE INC., Cupertino, CA (US)

(21) Appl. No.: 12/608,907

(22) Filed: Oct. 29, 2009

(51) Int. Cl. H04N 7/01; H04N 5/45

(52) U.S. Cl. 348/441; 348/565; 345/173; 348/E07.003; 348/E05.112

(57) ABSTRACT

A device to display moving images with a picture-in-picture effect. A memory that stores values is coupled to a display screen. The display screen displays images according to the values stored in the memory. A first receiver receives a first sequence of images and stores image data in a first portion of the memory. A second receiver receives a second sequence of images and stores image data in a second portion of the memory that is different than the first portion of the memory. The memory may be a multi-ported memory and the first and second receivers store image data independently of one another. The memory may include independent first and a second memories respectively coupled to the receivers and a data selector may selectively connect the display to one of the memories to display images with a picture-in-picture effect.

### BACKGROUND

1. Field

Embodiments of the invention relate to the field of video displays; and more specifically, to picture in picture video displays.

2. Background

“Picture in picture” type displays in which a smaller picture is inset into a larger picture may be useful to provide a preview of a second image while viewing the larger first image. A “picture in picture” display may more generally include a display where the smaller picture is displayed alongside the larger picture rather than being inset.

A “picture in picture” display is a useful device for video conference call applications in which a larger image shows a remote party and a smaller image shows a local party. A “picture in picture” effect may be created by using an image processor to create a composite image from the two images to be displayed. While this produces a good result, the use of an image processor increases the electrical power demand of the display system.

It would be desirable to provide a “picture in picture” display that could be used in mobile devices, such as cellular telephones, where it is important to conserve electrical power which is provided by a battery.

### SUMMARY

A device to display moving images with a picture-in-picture effect. A memory that stores values is coupled to a display screen. The display screen displays images according to the values stored in the memory. A first receiver receives a first sequence of images and stores image data in a first portion of the memory. A second receiver receives a second sequence of images and stores image data in a second portion of the memory that is different than the first portion of the memory. The memory may be a multi-ported memory and the first and second receivers store image data independently of one another. The memory may include independent first and a second memories respectively coupled to the receivers and a data selector may selectively connect the display to one of the memories to display images with a picture-in-picture effect.

The device may include an image multiplexer coupled to the memory and the receivers to periodically transfer at least part of an image selected from one of the two sequences of images to the memory. The unselected image may be discarded. The ratio of images selected from the first sequence to the number of images selected from the second sequence may be greater than one.

An image scaler may change the spatial resolution of the image data from the second receiver before it is stored in the second portion of the memory. A touch input may be received to position the second portion of the memory according to the touch input. A touch input may be received to resize the second portion of the memory according to the touch input.

Other features and advantages of the present invention will be apparent from the accompanying drawings and from the detailed description that follows below.

### BRIEF DESCRIPTION OF THE DRAWINGS

The invention may best be understood by referring to the following description and accompanying drawings that are used to illustrate embodiments of the invention by way of example and not limitation. In the drawings, in which like reference numerals indicate similar elements:

FIG. 1 is a simplified block diagram of a device that provides a picture in picture display.

FIG. 2 is a simplified block diagram of another device that provides a picture in picture display.

FIG. 3 is a simplified block diagram of yet another device that provides a picture in picture display.

FIG. 4 is a temporal representation of the picture in picture display provided by the device illustrated in FIG. 3.

FIG. 5 is another picture in picture display that may be provided by embodiments of the invention.

FIG. 6 is a flowchart of a method for providing a picture in picture display.

FIG. 7 is a flowchart of another method for providing a picture in picture display.

FIG. 8 is a flowchart of yet another method for providing a picture in picture display.

FIG. 9 is a flowchart of a method for adjusting a picture in picture display based on touch input.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

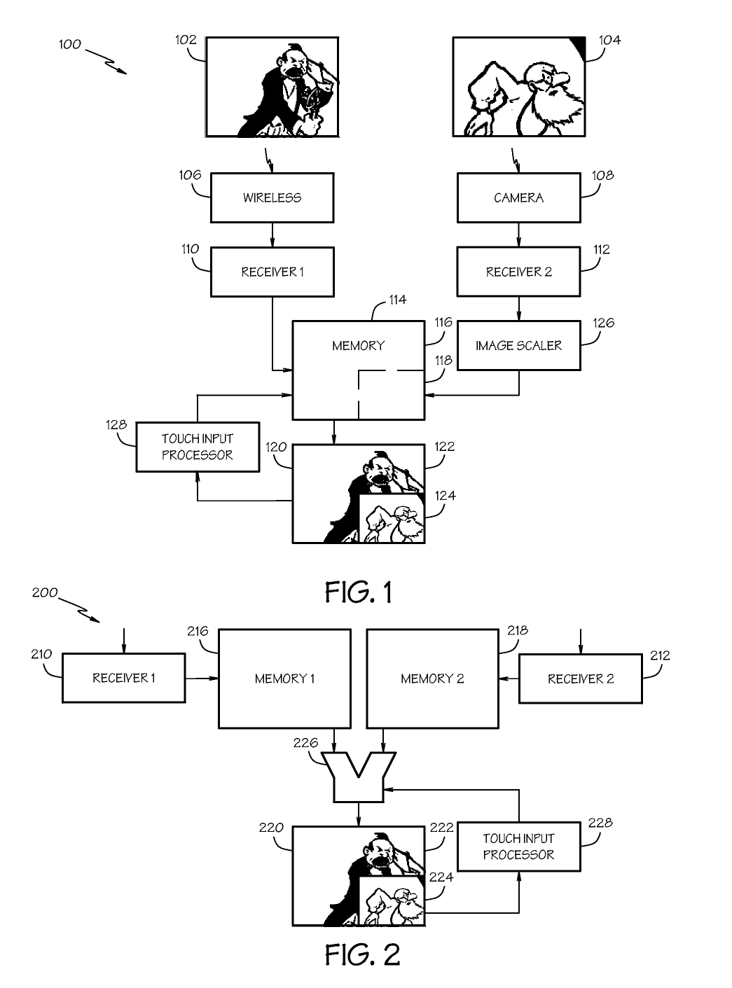

FIG. 1 is a simplified block diagram of a device 100 that displays moving images with a picture-in-picture effect. The device 100 may be included in a mobile multifunction device such as a cellular telephone, a personal digital assistant, or a mobile entertainment device. The device 100 may be particularly useful for creating a display to be used for video chats where a large image of the remote party is presented along with a smaller image of the local party. Many aspects of the device 100, such as power supply, lights, autofocus and zoom mechanisms, and other aspects that are not immediately relevant to the instant invention have been omitted to avoid obscuring the relevant aspects of the device.

The device 100 includes a memory 114 that is coupled a display screen 120. The display screen creates an image by setting the color and brightness of picture elements (pixels) of the display according to values stored in the memory. The display 120 is periodically refreshed by reading the values stored in the memory 114. If the values are updated at a frequent rate, such as at the same rate as the display is refreshed, a sequence of images can be presented to a viewer to provide moving images on the display.

The device 100 further includes a first receiver 110 and a second receiver 112, each receiver coupled to the memory 114. In the exemplary embodiment shown in FIG. 1, the first receiver 110 is coupled to a wireless connection 106 to receive a first sequence of images of a remote party 102 to a video conference call. The second receiver 112 is coupled to a camera 108 to receive a second sequence of images of a local party 104 to the video conference call. It will be appreciated that the first and second receivers may receive sequences of images from other sources, such as video text generators, stored video, and the like, in other embodiments.

The first receiver 110 stores the image data from the received first sequence of images in a first portion 116 of the memory 114. The second receiver stores the image data from the received second sequence of images in a second portion 118 of the memory 114 that is different than the first portion 116 of the memory. This provides a “picture in picture” display because the display 120 receives image data from the first sequence of images to provide a first part 122 of the display, and receives image data from the second sequence of images to provide a second part 124 of the display.

It will be appreciated that this device 100 allows the “picture in picture” display to be created with little increase in processing power as compared to a display of a single sequence of images because it only requires that the image data from the two sources 106, 108 be transferred to the memory 114 in an appropriate manner. It is not necessary to insert a video processor to create composite images in the path between the source of the images 106, 108 and the memory 114 or the display 120.

It will be appreciated that the second sequence of images may need to be scaled and/or positioned in second portion 118 of the memory 114 to produce the desired visual arrangement of the display 120. The device 100 may include an image scaler 126 that changes the spatial resolution of the image data from the second receiver 112 before it is stored in the second portion 118 of the memory 114. The image scaler 126 may simply select 1 of n pixels to scale the image or it may employ resampling to provide a greater selection of scaled sizes.

The image scaler 126 may cooperate with the memory 114 to adjust the position of the second portion 118 within the memory 114 to control where the second sequence of images 124 are presented on the display 120.

The display screen 120 may further receive a touch input to adjust the position of the smaller image on the display and the device may include a touch screen processor 128 that cooperates with the memory 114 to position the image 124 from the second sequence of images 104 according to the touch input by positioning the second portion 118 within the memory 114.

The display screen 120 may further receive a touch input to adjust the size of the smaller image 124 on the display 120 and the touch screen processor 128 may cooperate with the memory 114 to resize the second portion 124 of the memory 114 and the scaling of the image data 104 from the second receiver 112 according to the touch input.

In one embodiment, the memory 120 may be a multi-ported memory and the first and second receivers 110, 112 may store image data independently of one another. Multi-ported memory is used to mean memory that provides two or more independent data paths to the memory contents. It will be appreciated that the independent data paths may be provided by time division multiplexing of a single physical data path to the memory with sufficient bandwidth to accommodate the aggrate bandwidth requirements of the multiplexed data paths provided.

FIG. 2 illustrates another embodiment 200 of the inventive device in which the memory includes a first memory 216 and a second memory 218. The first memory 216 is coupled to the first receiver 210 and the second memory 218 is coupled to the second receiver 212. The first and second memories are independent of one another which may simplify the storing of image data from the received first sequence of images in the first memory 216 and the storing of the image data from the received second sequence of images in the second memory 218. Because this arrangement permits the use of a slower memory transfer rate, the power consumed by the device may be reduced.

A data selector 226 may be coupled to the first memory 216, the second memory 218, and the display 220. The data selector 226 may selectively connect the display 220 to one of the first 216 and second 218 memories to display images with a picture-in-picture effect. The data selector 226 may connect the display 220 to the first memory 216 when data is being transferred to a first area 222 of the display 220. The data selector 226 may connect the display 220 to the second memory 218 when data is being transferred to a second area 224 of the display 220.

The data selector 226 may change the spatial resolution of the image data as it is transferred from the second memory 218 to the second area 224 of the display 220. Thus the data selector 226 may provide the function of an image scaler. The data selector 226 may also adjust the position of the second sequence of images 224 on the display 220.

The display screen 220 may further receive a touch input to adjust the position of the smaller image on the display and the device may include a touch screen processor 228 that cooperates with the data selector 226 to position the second sequence of images 224 on the display 220 according to the touch input.

The display screen 220 may further receive a touch input to adjust the size of the smaller image on the display. The touch screen processor 228 may cooperate with the data selector 226 to resize second sequence of images 224 on the display 220 according to the touch input.

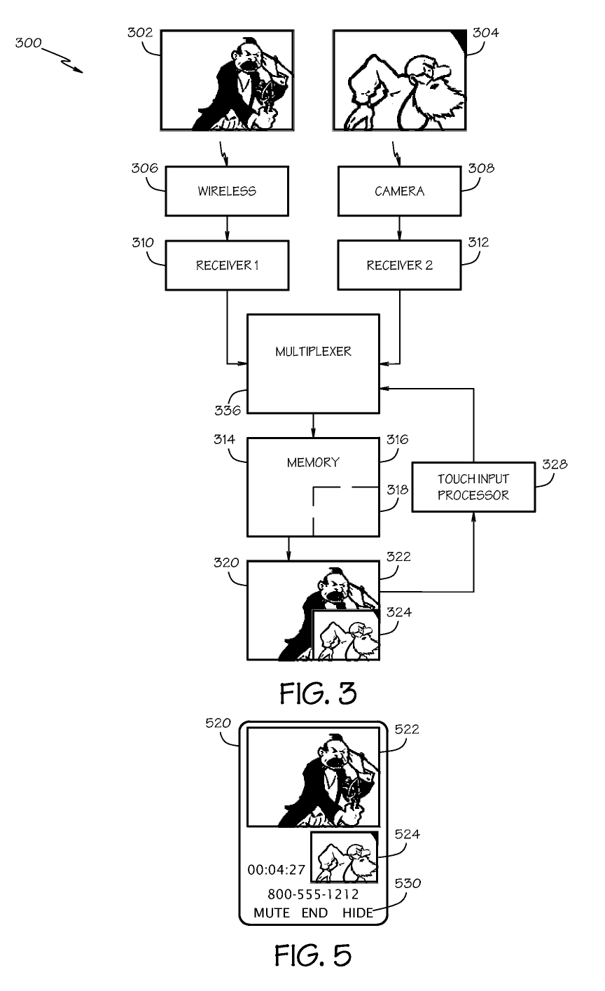

FIG. 3 illustrates yet another embodiment 300 of the inventive device in which an image multiplexer 336 is coupled to the memory 314, the first receiver 310, and the second receiver 312. The image multiplexer 336 periodically transfers at least part of an image selected from one of the first sequence of images 302 and the second sequence of images 304 to the memory 314. Images selected from the first sequence of images 302 are transferred to a first portion 316 of the memory 314. Images selected from the second sequence of images 304 are transferred to a second portion 318 of the memory 314 that is different than the first portion 316 of the memory. This provides a “picture in picture” display because the display 320 receives image data from the first sequence of images to provide a first part 322 of the display, and receives image data from the second sequence of images to provide a second part 324 of the display

When the image multiplexer transfers an image selected from the first sequence of images, an image from the second sequence of images may be discarded. Likewise, when the image multiplexer transfers an image selected from the second sequence of images, an image from the first sequence of images may be discarded. The ratio of the number of images selected from the first sequence during a time period to the number of images selected from the second sequence during the same time period may be greater than one because it will generally be desirable to show more images selected from the first sequence.

The image multiplexer 336 may also function as an image sampler that changes the spatial resolution of the image data from the second receiver before it is stored in the second portion of the memory. The image multiplexer 336 may also adjust the position of the second sequence of images 324 on the display 320.

The display screen 320 may further receive a touch input to adjust the position of the smaller image on the display and the device may include a touch screen processor 328 that cooperates with the image multiplexer 336 to position the second sequence of images 324 on the display 320 according to the touch input.

The display screen 320 may further receive a touch input to adjust the size of the smaller image on the display. The touch screen processor 328 may cooperate with the image multiplexer 336 to resize second sequence of images 324 on the display 320 according to the touch input.

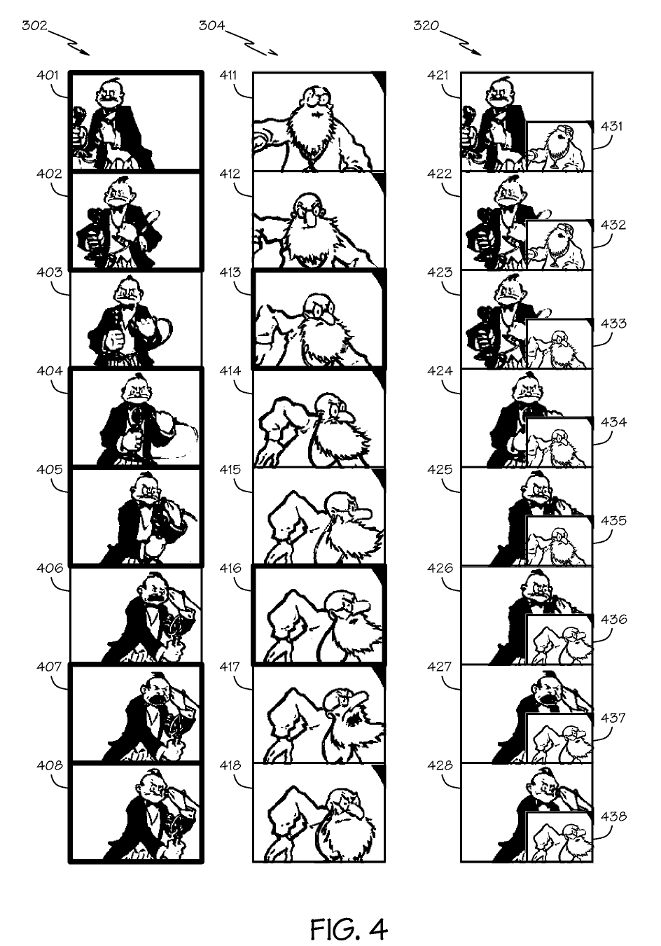

FIG. 4 illustrates the display 320 provided by the image multiplexer 336. Eight images 401-408 from an exemplary first sequence of images 302 and eight images 411-418 from an exemplary second sequence of images 304 are shown. Eight resulting images 421-428 that would be shown on the display 320 are also illustrated.

For purposes of illustration, the ratio of the number of images selected from the first sequence 302 to the number of images selected from the second sequence 304 is 2:1. In practice, the ratio would normally be greater, perhaps 5:1 or even 15:1. The multiplexing of the two images may create an uneven cadence in which a frame from the first sequence 302 is displayed without change for two refresh cycles of the display 320 when the display is updated with a new image from the second sequence 304. This may create a judder in the display of the first sequence. The judder may be made less perceptible by using a high ratio between selection of the first and second images. However, using a high ratio means that the second image is updated less frequently which places an upper limit on the ration that will produce a pleasing display.

In the exemplary sequences illustrated in FIG. 4, the multiplexer 336 selects images 401-402 from the first sequence 302 for the first two display frames 421-422 illustrated. In these two frames, the second image 431-432 remain unchanged from an image selected from the second sequence 304 earlier. In the third display frame 423, the second image 433 is updated while the first image remains unchanged. Heavy outlines indicate the frames that are selected 401, 402, 413 from the first 302 and second 304 sequences. Two frames 411, 412 are discarded from the second sequence 304 and one frame 403 is discarded from the first sequence 302.

In the next three display frames 424-426, the first two images 404, 405 from the first sequence 302 are displayed and the third 406 is discarded. The first two images 414, 415 from the second sequence 304 are discarded and the third 416 is displayed 436. This pattern is repeated every three frames for the exemplary 2:1 ratio shown.

FIG. 5 is another picture in picture display 520 that may be provided by embodiments of the invention. The first image 522 from the first sequence of images is shown in its entirety with the second image 524 from the second sequence of images shown adjacent to the first image. The second image 524 may be shown at a reduced size as illustrated. Informational text 530 or other video content may be displayed adjacent to the first 522 and second 524 images.

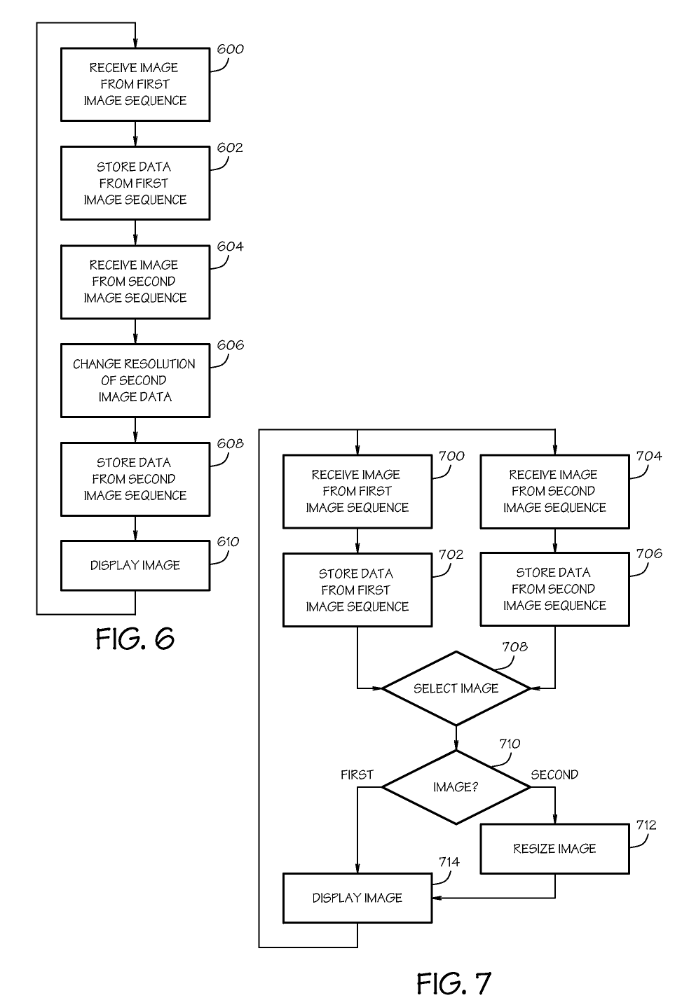

FIG. 6 is a flowchart of a method for displaying moving images with a picture-in-picture effect. A first image is received from a first sequence of images 600. Image data for the first image is stored in a first portion of a memory 602. A second image is received from a second sequence of images 604. The resolution of the second image may be changed to resize the display of the second image 606. Image data for the first image is stored in a second portion of the memory that is different than the first portion of the memory 608. An image that combines the first and second images to provide a picture-in-picture effect, which may also be a display where the smaller picture is displayed alongside the larger picture rather than being inset, is displayed by transferring the image data from the memory to a display system that displays images on a display screen according to the values stored in the memory 610.

FIG. 7 is a flowchart of another method for displaying moving images with a picture-in-picture effect. A first image is received from a first sequence of images 700. Image data for the first image is stored in a first portion of a memory 702. A second image is received from a second sequence of images 704. Image data for the first image is stored in a second portion of the memory that is different than the first portion of the memory 706. The first portion and the second portion of the memory are independent of one another which allows the receiving and storing of images from the two image sequences to proceed in parallel. Image data is transferred to a display system by selecting image data from one of the memory portions according to what area of the display will show an image for the data transferred 708. If the second image is selected for transfer to the display, the second image may be resized 712. An image is displayed that provides a picture-in-picture effect according to the image data that is transferred 714.

FIG. 8 is a flowchart of yet another method for displaying moving images with a picture-in-picture effect. A first image is received from a first sequence of images 800. A second image is received from a second sequence of images 802. One of the two images is selected to update the display 804. If the second image is selected for transfer to the display, the second image may be resized 808. At least a portion of the selected image is stored in a memory 810. If the second image is displayed as an inset in the first image, then the portion of the first image that is overlaid by the second image will not be stored in the memory. The received image that is not selected is discarded by inaction. An image is displayed that provides a picture-in-picture effect according to the image data that is transferred 812.

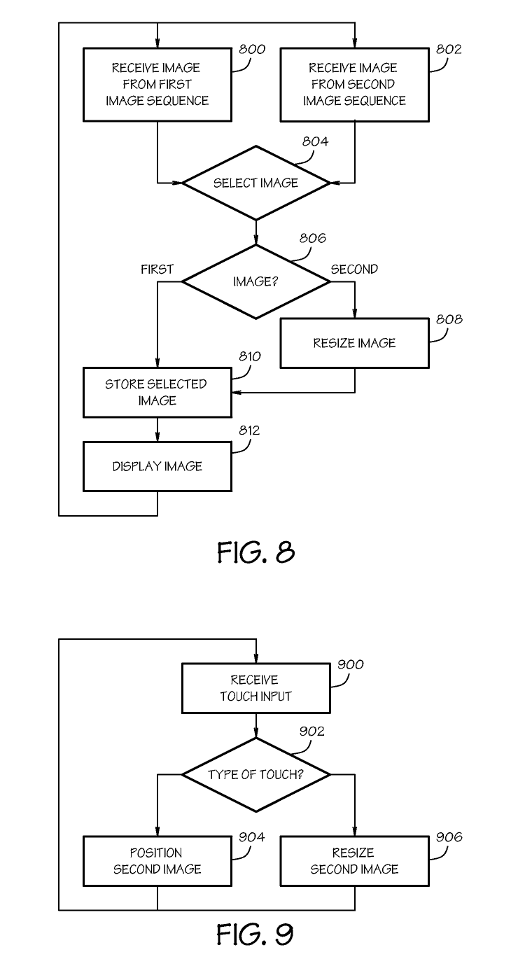

FIG. 9 is a flowchart of a method for adjusting the size and/or position of the second image for the picture-in-picture effect. This method may be used in conjunction with any of the previously described methods for displaying moving images with a picture-in-picture effect. A touch input is received 900. The type of touch input, position or resize, is determined 902. If a position input, such as a dragging motion, is received, the image from the second sequence of images is positioned according to the touch input 904. Positioning may be accomplished by changing where the image data from the second sequence of images is stored in the memory before it is transferred to the display. If a resize input, such as a pinching or stretching, is received, the image from the second sequence of images is resized according to the touch input 906. Resizing may be accomplished by changing the scaling of the image data from the second sequence of images before it is stored in the memory and adjusting the extents of the second portion of the memory where the image data is stored.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A device to display moving images with a picture-in-picture effect, the device comprising:
a memory that stores values;
a display screen coupled to the memory, the display screen to display images according to the values stored in the memory;
a first receiver coupled to the memory, the first receiver receiving a first sequence of images and storing image data from the received first sequence of images in a first portion of the memory; and
a second receiver coupled to the memory, the second receiver receiving a second sequence of images and storing image data from the received second sequence of images in a second portion of the memory that is different than the first portion of the memory.

2. The device of claim 1, wherein the memory is a multi-ported memory and the first and second receivers store image data independently of one another.

3. The device of claim 1, wherein the memory further comprises a first memory coupled to the first receiver and a second memory coupled to the second receiver, the first and second memories being independent of one another, and further comprising a data selector coupled to the first memory, the second memory, and the display, the data selector to selectively connect the display to one of the first and second memories to display images with a picture-in-picture effect.

4. The device of claim 1, further comprising an image multiplexer coupled to the memory, the first receiver, and the second receiver, the image multiplexer periodically transferring at least part of an image selected from one of the first sequence of images and the second sequence of images to the memory.

5. The device of claim 4, wherein an image from the second sequence of images is discarded when the image multiplexer transfers an image selected from the first sequence of images, and an image from the first sequence of images is discarded when the image multiplexer transfers an image selected from the second sequence of images.

6. The device of claim 5, wherein a ratio of a number of images selected from the first sequence during a time period to a number of images selected from the second sequence during the time period has a value greater than one.

7. The device of claim 1, further comprising an image scaler that changes the spatial resolution of the image data from the second receiver before it is stored in the second portion of the memory.

8. The device of claim 1, wherein the display screen further receives a touch input and the device further compromises a touch screen processor that positions the image from the second sequence of images according to the touch input.

9. The device of claim 1, wherein the display screen further receives a touch input and the device further comprises a touch screen processor that resizes the image from the second sequence of images according to the touch input.

10. A method for displaying moving images with a picture-in-picture effect, the method comprising:
receiving a first sequence of images;
storing image data from the received first sequence of images in a first portion of a memory;
receiving a second sequence of images;
storing image data from the received second sequence of images in a second portion of the memory that is different than the first portion of the memory; and
displaying images on a display screen according to the values stored in the memory.

11. The method of claim 10, wherein the first portion and the second portion of the memory are independent of one another, and the method further comprises selectively connecting the display to one of the first and second portions to display images with a picture-in-picture effect.

12. The method of claim 10, further comprising periodically selecting an image from one of the first sequence of images and the second sequence of images, transferring the selected image to the memory, and discarding the unselected image.

13. The method of claim 10, further comprising changing the spatial resolution of the image data from the second sequence of images.

14. The method of claim 10, further comprising receiving a touch input and positioning the image from the second sequence of images according to the touch input.

15. The method of claim 10, further comprising receiving a touch input and resizing the image from the second sequence of images according to the touch input.

16. A device for displaying moving images with a picture-in-picture effect, the device comprising:
means for receiving a first sequence of images;
means for storing image data from the received first sequence of images;
means for receiving a second sequence of images;
means for storing image data from the received second sequence of images that is different than the means for storing image data from the received first sequence of images; and
means for displaying images on a display screen according to the stored image data.

17. The device of claim 16, wherein the means for storing image data from the received first sequence of images and the means for storing image data from the received second sequence of images are independent of one another, and the device further comprises means for selectively connecting the display screen to one of the means for storing image data to display images with a picture-in-picture effect.

18. The device of claim 16, further comprising means for periodically transferring at least part of an image selected from one of the first sequence of images and the second sequence of images to the means for storing image data and discarding an image from the other of the first sequence of images and the second sequence of images.

19. The device of claim 16, further comprising means for changing the spatial resolution of the image data from the second sequence of images.

20. The device of claim 16, further comprising means for receiving a touch input and means for positioning the image from the second sequence of images according to the touch input.

21. The device of claim 16, further comprising means for receiving a touch input and means for resizing the image from the second sequence of images according to the touch input.
